(19) United States
(12) Patent Application Publication
(10) Pub. No.: US 2023/0132751 A1
(43) Pub. Date: May 4, 2023

(54) 3D PRINTED DIAMOND ABRASIVE STRUCTURES WITHOUT THE USE OF A MOLD

(71) Applicant: Inland Diamond Products Company, Madison Heights, MI (US)

(72) Inventor: Andrew C. Wiand, Troy, MI (US)

(73) Assignee: Inland Diamond Products Company, Madison Heights, MI (US)

(21) Appl. No.: 17/976,304

(22) Filed: Oct. 28, 2022

Related U.S. Application Data
(60) Provisional application No. 63/273,472, filed on Oct. 29, 2021.

(51) Int. Cl. C04B 35/532; B24D 11/00; C04B 35/565; C04B 35/626; C04B 35/634; C04B 35/638; C04B 35/64; B29C 64/124; B33Y 70/10; B29C 64/30; B33Y 10/00; B33Y 40/20

(52) U.S. Cl. CPC C04B 35/532; B24D 11/001; C04B 35/565; C04B 35/6269; C04B 35/63424; C04B 35/638; C04B 35/64; B29C 64/124; B33Y 70/10; B29C 64/30; B33Y 10/00; B33Y 40/20; C04B 2235/3826; C04B 2235/427; C04B 2235/3217; C04B 2235/6026; B29K 2509/04

(57) ABSTRACT

A resin bonded super abrasive tool. The tool is manufactured using a liquid 3D light cured solution printer (3D printing which uses a liquid resin super abrasive and secondary fillers). The liquid resin is mixed with effective amounts of the super abrasive material and secondary fillers, and they are co-deposited and cured by printer during the 3D printing process.

### CROSS-REFERENCE TO RELATED APPLICATIONS

This application is a Non-Provisional Patent Application and claims benefit of U.S. Provisional Patent Application No. 63/273,472, filed Oct. 29, 2021. The disclosure of the above application is incorporated herein by reference.

### FIELD OF THE INVENTION

The present invention relates to 3D printed diamond wheels without the use of a mold.

### BACKGROUND

In most diamond tool manufacturing companies, which are not solely electroplated diamond tool and saw manufacturers, 99% of what they make is made using molds. Molds are very expensive and labor intensive to fill with the diamond bonding materials. Diamond wheels are very labor intensive to make, have many machining processes, required to be oversized dimensions, require an expensive mold which wears rapidly from the abrasive nature of the process and heat/pressure to which it is subjected and has a very high value to weight or size.

Therefore, there remains a need in the art to provide mold less customizable abrasive articles which are easier and cheaper to manufacture. With the present invention if you can make a 3D digital representation of the abrasive article, you can make the article.

### SUMMARY OF THE INVENTION

A resin bonded super abrasive tool printed with stereolithography using a curable or hardenable binder material with diamond abrasive grit mixed in. In one embodiment, the tool is manufactured using a liquid 3D light cured solution printer (3D printing which uses a liquid resin super abrasive and secondary fillers). The liquid resin is mixed with effective amounts of the super abrasive material and secondary fillers, and they are co-deposited and cured by printer during the 3D printing process. The abrasive article is either permanently or temporarily deposited on a substrate during printing; alternatively, a re-enforcing material can be incorporated into the abrasive article during the 3D printing operation. Other types of 3D printers could also be used.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of abrasive pads made in accordance with the present invention; and

FIG. 2 is a more detailed view of FIG. 1.

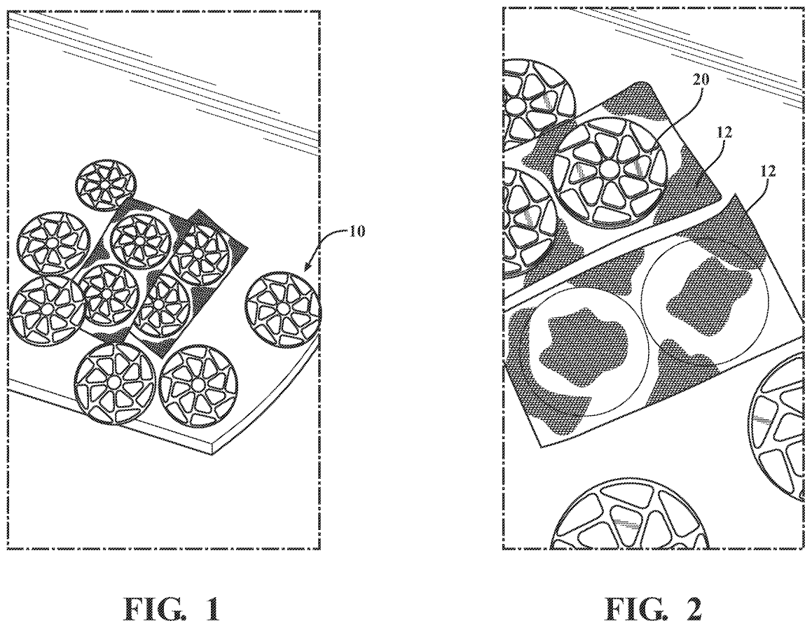

### DETAILED DESCRIPTION OF THE PREFERRED EMBODIMENTS

The following description of the preferred embodiment(s) is merely exemplary in nature and is in no way intended to limit the invention, its application, or uses.

In the present invention there is provided the manufacturing of diamond tools of the classes; resin bonded (both thermal set and thermal plastic, vitrified (ceramic/glass free sintered), metal bonded (powder metal sintered), by 3D printing; but not electroplate plated (electro form or co-deposited galvanic), diamond wheels or other three-dimensionally formed abrasive articles containing diamond like hardness and/or other abrasive grit materials.

3D printer heads exist to print from a liquid, slurry, powder or paste. In the present invention, using 3D printer technology, diamond tools and wheels are manufactured without the use of a mold in which to contain them during processing to give them their three-dimensional shape. Also, one skilled in the art could imagine that even a single layer of diamond crystals could be bonded to a substrate like a sanding paper. This would save on the high cost of mold, labor, diamond core materials and overhead. Unlike normally printed, 3D printed items are very low labor content, diamond wheels such as used in the ophthalmic industry are very labor intensive to make, have many machining processes, required to be oversized dimensions, require an expensive mold which wears rapidly from the abrasive nature of the process and heat/pressure to which it is subjected and has a very high value to weight or size.

For example, a resin bonded monomer/oligomer based bonded pad such as those shown at 10 is manufactured by using thermal or UV cured 3D printing or even a liquid phenolic resin mixture. The monomer/oligomer is mixed with diamond grit hardness materials, such as natural or synthetic diamonds corundum, tungsten carbide, garnets, silicon carbide, cubic boron nitride, coated diamond, and secondary abrasives and fillers such as silicon carbides, aluminum oxides including corundums, and mixtures thereof. This forms a liquid or perhaps a paste like mixture, then by either mixing into the paste a UV curing agent to form a single printable component which by the 3D printer head in the presence of a UV light at which time it is instantly cure solid or alternatively by using an injection head 3D printer a curing agent and the mixture of diamond and fillers to the printer head at which point they are thoroughly mixed as they pass through a mixing nozzle just prior to being deposited into the exact needed 3D position on a heated stage or environment. In a preferred embodiment UV light curable materials are preferred. These 3D printers provide a built-in mixing function by the nature of the movement of the printing bed movements such that continual mixing of the materials is unnecessary.

Similarly, monomers, oligomers and other liquid resins of a thermal set nature can be a mixture to form a viscose or non-viscose mixture; printed with UV curing agents and printed to the required shape. With thermal cured mixtures, it would require printing slowly over a UV light curing source of 405 NM. Preferably, a pixelated UV light source under the liquid mixture. UV cured accelerators used in resins usually are sufficiently cured by the UV light source to give the desired mechanical properties needed but could also be post cured to modify the properties of the resultant tool. It is to be appreciated that you cannot completely cure a thick cross-section of the diamond and filler mixture because the UV light is blocked by the fillers. However, in the present preferred UV curing process the printer applies a thin 3D printed layer to a substrate such as a mesh shown at 12. Thus, the UV light can reach all the accelerant throughout the thick cross-section and cure the resin but laying down a fully curable layer at a time.

Thus, as shown in FIG. 2 granite polishing pads are shown with and without a strengthening or attachment backing. Backing material 12 can be a strengthening mesh, Velcro® hook and loop fasteners or other fastener materials for fastening of the pad to a tool or the like.

Sintering in of 3D printed thermoplastic materials like PPS (polyphenylene sulfide), a high temperature engineering plastic could be 3D printed at about 300-degrees F. Sintering of thermal plastics is a new concept and PPS lends itself well to this art. After mixing the diamond fillers and PPS with a binding and a fluid to allow dispensing of the paste mixture through a 3D printer head, the printer grinding tool would be subjected to a long heating cycle to get the PPS particles to essentially sinter, forming a solid body.

Likewise, vitrified bond diamond tools can be produced using a paste type formulation, 3D printed and then fired in a kiln. A mixture of diamond fillers and fusible alumina materials are liquid 3D printed to the desired shape then fired in a kiln to burn off the resin binders from the 3D printing process and fuse the alumina materials into an abrasive body.

Generally, the 3D printing equipment already exists to carry out all of these processes. Suitable equipment is available from Formlabs Inc. of Somerville, Mass., U.S.

Very similarly, all of these modalities could be practiced by making molds, even 3D printed molds and using CNC epoxy glue or potting equipment to fill the mold cavities, followed by the appropriate curing. Suitable printing processes include:
A. Filament Printing
   FFF/FDM
   Making filament with diamond and fillers mixed in
B. Liquid Resin Printing (diamond and fillers mixed in)
   SLA
   DLP
   LCD/MLCD
   Volumetric
   HARP
C. Selective Laser Printing (low watt lasers 5 watts to 100 watts for drying, setting binders or resins
   DMLS
   Jet Fusion
D. Binder Jetting Printing or Powder based printing

By the above methods, abrasive structures such as insert printed parts can be made, wherein an abrasive body is encapsulated in the plastic print media, or a non-abrasive body is encapsulated in the abrasive containing print media. The process can be used to make most any type of abrasive part now made with molds or injection insert molding techniques.

It should be noted that any of the 3D printing techniques described which could require a post sintering of curing process after printing could be subjected to an intermediate cold press or densification process before the final heating or sintering.

In an alternate embodiment a binder jet printing process is used for creating a three-dimensional abrasive pad or other abrasive article. This process includes the steps of:
a. Providing a 3D printer using a temporary binder material, said 3D printer including a surface to print on;
b. Adding a dusting layer of abrasive grit material, secondary abrasives and fillers and permanent binder to said surface; and,
c. Printing a layer of temporary binder material over the dusting layer to form a green part layer.

In this process resin bonded, metal bonded and even single layer products are produced.

It offers the advantage of no scrap or unusable material. You can make a resin or metal diamond tool. The process can print a metal and resin body with diamond and filler mixed into the powders used. Or you can make a metal powder matrix body which has a water and flour binder, glue or can use any binder which can be dried or cured to a solid.

In one embodiment the powder material being comprised of metal diamond bonding powders and diamond; the binder would be a combustible UV cure resin or any binder, the printed part put into a furnace to burn off the binder, the resultant porous metal diamond matrix is then placed in a furnace to be free sintered without a mold. This is used to form segments, rings, pads etc. to form diamond abrasive tools. It could also be used to form parts which have inserts of diamond matrix parts bound together with metal or plastic non-diamond bearing materials.

Single layer diamond abrasive sheets of material or single layer diamond abrasive tools can also be manufactured by putting a single layer of the abrasive powder with or without secondary abrasives on a substrate and it does not need to be planar.

In the binder jet process the powder mixture of diamond grit and metal or other final binders and filler is deposited on the surface, the binder is printed onto the layer for creating a slice of the three-dimensional object. This process is repeated to form a three-dimensional abrasive pad structure. In this process a Binder Jet 3D type printer is used.

Finally, wherever the word diamond is used, it is meant as super abrasives materials, such as diamond, coated diamond, cubic boron nitrite, both coated and uncoated and the like.

### Example 1

We have used three (3) different resins to print the pads, two (2) were commercially available off the shelf at Micro Computer Center in Madison Heights, Mich., U.S. and the most promising was a special formulation made for us, by Sartomer Div. of Arkema, Inc., known as PRO14143, a photo-initiated acrylate liquid resin cure with 405 NM UV light.

A strengthening element for the pads by co-deposit printing of a mesh layer at the base of the pad (the mesh is attached to the printer bed) is also used. The mesh is encapsulated by printing plastic thereover. After the mesh is encapsulated in the plastic buildup, we continue to print or deposit the main body of the pad beyond the thickness of the mesh. In this manner we have printed 3 mm and 10 mm thick abrasive pads.

A first unexpected result was that the UV liquid printing could be carried out in resins heavily loaded with abrasives and secondary fillers. The heavily loaded liquid resins did not stop the UV light from curing the liquid resin.

But, the most unexpected result was that the up and down action of the printer bed, which moves up and down between each print layer cycle, created a pumping action which keeps the particulate matter in the resin homogeneously suspended in the resin producing a pad which is homogenous throughout.

Cylinder parts 35 mm in diameter and 8 mm tall to make a rotary diamond tool are also manufactured using this process. In another example forming of a core ore body to which he would bond the cylindrical diamond section to grind with is manufactured

Listed below are the formulae which have been used in printing abrasive structures.

Formulations Tested

| | Formualtion 1 | | | | Formulation 3 | |
|---|---|---|---|---|---|---|
| | Inland Resin | | Fomuation 2 | | Sartomer Resin | |
| Resin Weight | 200 | grams | 200 | grams | 200 | grams |
| Secondary Abrasives | 50 | grams | 25 | grams | 50. | grams |
| Diamond | 30.00 | cts | 30.00 | cts | 30.00 | cts. |

The advantages are that there is very little labor compared to the traditional injection molding of diamond polishing pads, the consistency is better, productivity is higher, and scrap is less.

FORMULATION #1a

Inland White Resin 200 grams

Filler: 25 grams 600 grit SiC

Diamond: JR-3 40/50 micron 30 cts.

FORMULATION #2a

SUPER-HDT Resin 200 grams

Filler: A1302 optical polishing grade 25 grams

Diamond: JR-3 2-3 micron 30.0 cts

FORMULATION #3a

Sartomer Resin 200 grams

Filler: Silicon Carbide 600 grit 25 grams

Diamond: JR-3 40/50 micron 30.0 cts.

We have used post cures with UV light and/or heating to find the optimal curing conditions.

Every sample tested is found to be suitable for taking stone or concrete to a polish.

When printing abrasive articles with a liquid resin the effective amount of liquid resin in percent by weight of liquid resin is found to range from about 10% to about 70% and preferably from about 20% to about 50% with the remainder being abrasive grit with or without fillers.

Grit sizes useable for mixing and stereolithographic printing are found to be from about 20 grit to about 1-2 micron.

In the binder jet the final binders are in the deposited powder and printing is accomplished using about 5% resin by weight. In the case where you build a metallic part that is to be sintered and/or infiltrated; there is the resin binder is burnt off first before sintering and/or infiltrating; to 80% in the case where we are making a part which is holding an abrasive insert and in the case of a resin abrasive body is being made 20-60 percent. In a single layer process, where the adhesive is laid down on a substrate, a layer of binder is deposited, followed by the abrasive media and then another layer of binder deposited on top, the binder is found to range from 10% to 80% depending on the application.

Where you are burning off the binder to make a sinter or infiltrated part, the binder could be organic or inorganic. They could be dried or cured by heat, UV light or a chemical reaction. Braze powders could be used as an infiltrate or the binder jetting is used as a method of distributing the abrasive grit onto a substrate for making a single layer brazed tool.

Also within the scope of the present invention is a filament type of printing where the abrasive media is mixed into the plastic and thereafter extruded into the filament and then formed by the 3D printer into an abrasive body or tool.

As will be readily appreciated the present process is broadly useful in all types of stereolithographic processes in this regard a three-axis epoxy gluing machine is used in an alternate embodiment. In this case, a liquid epoxy material including abrasives and/or fillers in the ratios above to form a self-curing three-dimensional abrasive article or a monolayer on a substrate surface.

While typically the abrasive articles of the present invention include there does not need to be both fillers and diamond, any of these methods my just have diamond in the binder.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A process for manufacture of an abrasive tool comprising:
providing a UV cure three-dimensional printer;
mixing an effective amount of an abrasive material with a printable UV curable polymer mixture which is used by the printer; and
printing a three-dimensional abrasive article from the mixture of abrasive material and printable material.

2. The process of claim 1 wherein the printer used is an SLA or MSLA 3D printer.

3. The process of claim 1 wherein the abrasive material is selected from diamond, corundum, tungsten carbide, garnets, silicon carbide, cubic boron nitride and coated diamond

4. The process of claim 3 wherein secondary fillers is included in the mixture selected from a group consisting of silicon carbides, aluminum oxides including corundums, and mixtures thereof.

5. The process of claim 1 wherein the 3D printer is a UV curable liquid resin type printer.

6. The process of claim 1 wherein the printable polymer material is a powdered material.

7. The process of claim 1 further comprising an intermediate cold press or densification process before the final heating or sintering curing step.

8. The process of claim 1 wherein a mono layer of abrasive containing printable material is deposited on a substrate.

9. The process of claim 1 wherein a multi abrasive layer abrasive article is printed.

10. The process of claim 1 wherein a base support structure is printed over to form an abrasive article to provide support and/or attachment options for the article.

11. The process of claim 1 wherein a reinforcing attachment mandrel is first provided such that the abrasive article is printed around the reinforcing attachment mandrel.

12. The process of claim 1 wherein a printed abrasive structure is sintered into a final structure.

13. A process of printing a three-dimensional abrasive structure comprising the steps of:
a. Providing a 3D printer using a temporary binder material, said 3D printer including a surface to print on;
b. Adding a dusting layer of abrasive grit material, secondary abrasives and fillers and permanent binder to said surface; and,
c. Printing a layer of temporary binder material over the dusting layer to form a green part layer.

14. The process of claim 13 wherein the steps b and c are repeated for forming a three-dimensional abrasive article with the temporary binder holding the structure in a three-dimensional shape and thereafter post treating the structure for driving off the temporary binder from the structure and allow said permanent binder to permanently hold the structure in the three-dimensional shape.

15. The process of claim 14 wherein the temporary binder is a hydrocarbon type binder that can be driven off with heat.

16. The process of claim 14 wherein the permanent binder is a metallic binder that is sintered to form the permanent bond.

17. The process of claim 14 wherein the permanent binder is a thermoforming or thermosetting polymer binder.

18. A process for manufacture of an abrasive tool comprising:
providing a stereolithographic printing machine;
mixing an effective amount of an abrasive material with a curable material which is used by the stereolithographic printing machine; and
printing a three-dimensional abrasive article from the mixture of abrasive material and curable material.

19. The process of claim 18 wherein a UV curable material is used

20. The process of claim 18 wherein a volatile binder is used to print a green 3D structure with a second permanent binder in the 3 D article which is hardenable by heat.

21. The process of claim 20 wherein the permanent binder is a metal or polymeric binder material.
